(19) United States
(12) Patent Application Publication
(10) Pub. No.: US 2005/0141012 A1
(43) Pub. Date: Jun. 30, 2005

(54) Image forming apparatus and information processing apparatus capable of communicating with the image forming apparatus

(75) Inventor: Hiroshi Oomura, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHI, Tokyo (JP)

(21) Appl. No.: 10/995,291

(22) Filed: Nov. 24, 2004

(30) Foreign Application Priority Data
Dec. 2, 2003 (JP) 2003-403555

(51) Int. Cl. G06F 15/00

(52) U.S. Cl. 358/1.14; 358/1.15

(57) ABSTRACT

An image forming apparatus has: a job command receiving unit for receiving a job command from an external apparatus; an image forming processing unit for executing an image forming process on the basis of said job command received by said job command receiving unit; and a charging unit for, if identification information of an additional function is included in said job command, executing a charging process regarding the image forming process by said additional function. An information processing apparatus which can communicate with the image forming apparatus is also disclosed.

### BACKGROUND OF THE INVENTION

1. Field of the Invention

The present invention generally relates to, for example, management of an image forming apparatus such as a printing apparatus or the like.

2. Related Background Art

In recent years, to raise an added value of a print result, there is a tendency that advanced novel additional functions such as copy guard function, form overlay, digital watermark, and the like are added to a printer driver. Since those additional functions generally have added values higher than those of the printing in many cases, they are onerous options and are not included in a fundamental printer driver set.

To suppress dependency on versions of a plurality of printer drivers or models of the printing apparatus as much as possible, those functions are provided as additional add-in (plug-in) modules having a common expansion interface.

There is such an advantage that even in the case of a combination with the fundamental printer driver set which was released in the past, merely by providing the add-in module, the novel additional function can be realized so long as it corresponds to the common expansion interface. In other words, by providing the novel function by the add-in, the functions which are not presumed at the beginning of sale of the printing apparatus and cannot be recognized by the printing apparatus can be also additionally added to the printer driver later.

Ordinarily, in a printing apparatus such as a multifunction printer or the like, there has been made a business model in which a charging contract is made between the user and the manufacturer and the user is charged for a consumption amount that the user used consumables such as sheets, toner, or the like (Japanese Patent Application Laid-Open No. 11-308398). With respect to the advanced added value functions, however, such a mechanism that in the printing apparatus, the user is charged only for the consumption amount of consumables used by him will be proposed in future.

However, the functions which are not presumed at the beginning of sale of the printing apparatus exist among the novel additional functions provided by the add-in modules, they cannot be recognized by the printing apparatus, and the charge cannot be made. The function such as a copy guard function which can be realized only by the add-in module main body and cannot be discriminated by a draw command or a job control command that is transferred to the printing apparatus exists. The charge for such a function cannot be also performed in the printing apparatus.

Therefore, at present, as a method of buying the novel additional functions by those add-in modules, there is only a blanket sale by a usual package unit. For example, there is a license form such as two-dimensional bar code or special font in which each time such a function is applied, its use fee is paid to a developing source of such a technique. Since only the blanket sale is presumed at present as add-in modules, the novel function of such a license form cannot be installed.

### SUMMARY OF THE INVENTION

It is an object of the invention to solve at least one of the above problems. It is a feature of the invention to make it possible to execute a charging process with respect to use of the novel additional functions which are not presumed at the beginning of development of an image forming apparatus such as a printing apparatus or the like.

According to an embodiment of the invention, there is provided an image forming apparatus comprising:
a job command receiving unit for receiving a job command from an external apparatus;
an image forming processing unit for executing an image forming process on the basis of the job command received by the job command receiving unit; and
a charging unit for, if identification information of an additional function is included in the job command, executing a charging process regarding the image forming process by the additional function.

According to another aspect of the embodiment, there is provided an information processing apparatus which can install a plug-in driver for forming output data which is transferred to an image forming apparatus and allowed to be output-processed, comprising:
an instructing unit for instructing whether or not a use situation of the plug-in driver is charged for by a measured rate before the plug-in driver is installed; and
a setting unit for activating a mechanism which is a function for managing the use situation of the plug-in driver and is possessed by the image forming apparatus side in the case where the instructing unit instructs to charge for by the measured rate.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram showing a module construction of a print system according to an embodiment of the invention;

FIG. 2 is a diagram showing an example of a user interface display screen of an add-in installer which is displayed when an add-in is installed;

FIG. 3 is a flowchart showing the operation in the add-in installer for displaying installation dialogs;

FIG. 4 is a flowchart showing a flow for processes in the case where a check box for paying in accordance with a use amount on the basis of a maintenance contract of a printing apparatus is selected;

FIG. 5 is a diagram showing an example of information for add-in registration;

FIG. 6 is a flowchart showing a flow for a registering process into a counter ID to add-in ID management counter in the printing apparatus;

FIG. 7 is a diagram showing a data structure of the counter ID to add-in ID management counter;

FIG. 8 is a flowchart showing the operation in a printer driver 106;

FIG. 9 is a diagram showing an example of job commands which are formed in the process shown in FIG. 8; and

FIG. 10 is a flowchart showing a flow for a charging process in a charging apparatus unit.

### DETAILED DESCRIPTION OF THE PREFERRED EMBODIMENTS

Embodiments of the present invention will now be described in detail in accordance with the accompanying drawings.

A preferred embodiment of the invention will be described in detail hereinbelow with reference to the drawings.

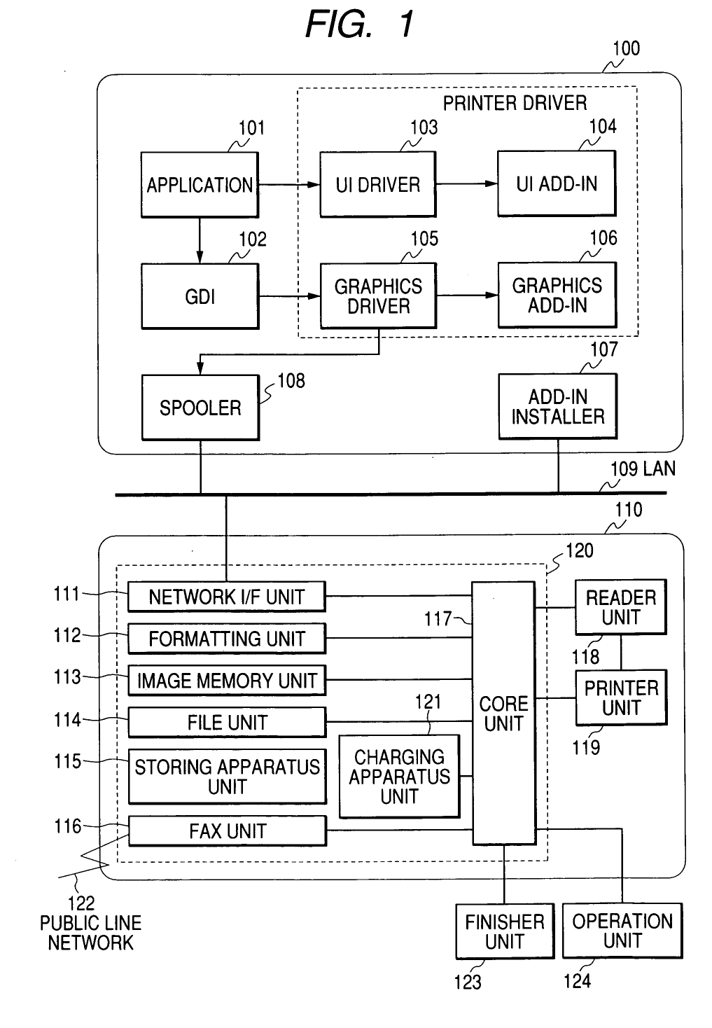

FIG. 1 shows a module construction of a print system according to the embodiment of the invention. The fundamental operation in the case where an add-in is included will now be described with reference to FIG. 1. An information processing apparatus 100 and a printing apparatus 110 are connected by an LAN 109 as a communication medium. Although the information processing apparatus 100 and the printing apparatus 110 are connected in a one-to-one correspondence relational manner here for simplicity of explanation, there is no problem even if a plurality of information processing apparatuses and a plurality of printing apparatuses are connected. Any connecting form other than the form using the LAN 109 can be used so long as bidirectional communication can be made.

Modules in the information processing apparatus 100 operate on an OS (Operating System; not shown). An application 101 is application software such as word processor, business form software, or the like which the user generally purchases from a software vender, installs onto the OS, and uses.

A GDI 102 and a spooler 108 are modules which are generally enclosed in the OS and distributed. The GDI 102 provides a drawing API (Application Programming Interface) which does not depend on a device to the application and is a graphics engine which is attached to the OS and used to convert a drawing API call from the application into a drawing call that includes draw information called DDI (Device Driver Interface) and that can be easily processed by the printer driver.

The spooler 108 is a module for receiving a job command which is formed by a graphics driver 105 and depends on the printing apparatus and distributing this job command to the external printing apparatus 110 of the information processing apparatus 100.

A UI driver 103 and the graphics driver 105 are modules which are provided from the vender of the printing apparatus 110. The UI driver 103 is a module for providing a user interface that is peculiar to the printing apparatus to the user so that a printing mode such as duplex printing, finisher, or the like which depends on the printing apparatus in accordance with a request from the application 101. The graphics driver 105 is a module which receives a DDI call of the GDI 102 and forms a job command depending on the device.

A UI add-in 104, a graphics add-in 106, and an add-in installer 107 are modules which are provided by the vender of the printing apparatus or a third party in order to add functions which are not presumed at the beginning of the development of them to the UI driver 103 and the graphics driver 105. The UI driver 103 or the graphics driver 105 have already been installed on the OS here and a system for additionally installing the UI add-in 104 and the graphics add-in 106 by using the add-in installer 107 will now be described.

Subsequently, the operations of those modules in the information processing apparatus 100 will be sequentially explained. An outline of the operations in the state where the UI add-in 104 and the graphics add-in 106 have already been installed is shown here.

When the user executes the printing by using the application 101, the application 101 calls the UI driver 103 in order to make detailed print setting such as duplex, finishing, or the like. The UI driver 103 displays a UI to urge the user to make the setting that is peculiar to the device. At this time, if the UI add-in 104 has already been installed, the UI add-in 104 is called and requested to execute an operation to display a UI for setting additional functions.

The UI add-in 104 adds items such as buttons for the additional functions, text designating box, and the like onto a user interface of the UI driver 104. Information for associating with a handler to each process is included in the items such as buttons, check boxes, and the like added onto a user interface of the UI driver 103 by the UI driver 103 and the UI driver 104. When the user operates the UI, the OS transfers the contents of the operation executed by the user to the handler associated with the item on each UI. The UI driver 103 and the UI add-in 104 records the operation contents as print setting information. At this time, for example, a contradictory point notification in the setting contents such as duplex printing to an OHP sheet or the like and a rounding process of the contradictory point are executed by the UI driver 103 and the UI add-in 104. When an OK button on the UI is clicked, the print setting information set at this time is sent to the application 101.

To realize the desired print setting of the user, the application 101 sends the print setting information to the GDI 102. After that, the drawing API which has been prepared by the GDI 102 and does not depend on the printing apparatus 110 is called, thereby forming a drawing image on each page constructing a document. The GDI 102 converts the print setting information and the draw information into a format of the DDI (Device Driver Interface) which can be interpreted by the graphics driver 105 and transfers it to the graphics driver 105.

The graphics driver 105 forms a job command on the basis of the print setting information and the DDI call. At this time, if the graphics add-in 106 exists, the print setting information and the DDI call are also transferred to the graphics add-in 106 and an opportunity of realizing the additional functions is provided to the graphics add-in 106. The job commands formed by the graphics driver 105 and the graphics add-in 106 are sent to the spooler 108 when it is set to a proper size in a command syntax or a data size upon transfer. The spooler 108 transfers the job commands to the proper printing apparatus 110 through a network.

Although the case of one printer driver has been described here, a plurality of printer drivers can also exist on the OS. In such a case, four modules regarding the printer driver surrounded by a broken line in FIG. 1 are managed as a related set by a storing device such as a registry or the like in the OS. The association with the printing apparatus 110 as a destination to which the job command which is formed by the printer driver is distributed is also managed by a storing device such as a registry or the like in the OS. Therefore, even if a plurality of drivers exist, it is guaranteed by the OS that the related modules are called at proper timing, respectively.

The add-in installer 107 is an installer module which is used when a novel additional function is added to the driver which has already been installed on the OS. Although the UI add-in 104 and the graphics add-in 106 are ordinarily included as an installation set, in a network environment, there is also a method whereby the necessary modules are collected from the network upon installation by the distribution of only the add-in installer 107 and installed.

A module construction of the printing apparatus 110 will now be described.

An example of the printing apparatus suitable for the print system according to the embodiment is shown in FIG. 1. That is, the printing apparatus 110 is a hybrid apparatus of a type in which functions of a scanner, a printer, a copying apparatus, and a facsimile are integrated and connected to the information processing apparatus 100 through a network. Further, the printing apparatus 110 is also connected to other communicating apparatuses through a public line network 122. The printing apparatus 110 is not limited to the example shown in FIG. 1 but can be a digital copying apparatus, a printer with a copying function, or the like. The number of peripheral devices connected to the network is not limited to the example shown in the diagram. The printing apparatus 110 is not limited to such a hybrid apparatus but can be an apparatus with a single function which can form an image like a printing apparatus such as facsimile, printer, or the like, a scanner apparatus, or the like. The printing apparatus 110 also includes a controller or the like built in each of those apparatuses. A counter can be also attached to a network board of each of various printing apparatuses, for example, to a network interface unit 111 or the like.

The printing apparatus 110 is mainly constructed by a reader unit 118, a printer unit 119, and an image input/output control unit 120. The reader unit 118 is connected to the printer unit 119 and the image input/output control unit 120, reads out an image of an original, and outputs the read image data to the printer unit 119 or the image input/output control unit 120. The printer unit 119 prints the image data outputted from the reader unit 118 or the image input/output control unit 120 onto recording paper. The image input/output control unit 120 is connected to an external network and the public line network 122, inputs/outputs an image, and executes storage of data indicative of a use amount when the user uses the printing apparatus 110, or the like. The image I/O control unit 120 further makes an analysis and control of the job commands from the information processing apparatus 100 connected to the network.

The image I/O control unit 120 is constructed by: a facsimile unit 116; a file unit 114; the network interface unit 111 as an example of communicating means for communicating with the information processing apparatus 100; a PDL formatting unit 112; an image memory unit 113; a storing apparatus unit 115; a charging apparatus unit 121; and a core unit 117 for connecting all of those units.

The FAX unit 116 is connected to the core unit 117 and the public line network 122, decompresses the compressed image data which was received from the public line network 122, and sends the decompressed image data to the core unit 117. The FAX unit 116 also compresses the image data transmitted from the core unit 117 and sends the compressed image data to the public line network 122.

The file unit 114 is connected to the core unit 117 and the storing apparatus unit 115, compresses the image data transmitted from the core unit 117, and stores the compressed image data into the storing apparatus unit 115 together with a keyword for searching for the compressed image data. Although a hard disk drive is used as a storing apparatus unit 115 in the embodiment, the invention is not limited to it. Further, the file unit 114 searches for the compressed image data which was stored in the storing apparatus unit 115 on the basis of the keyword transmitted from the core unit 117, reads out the compressed image data, decompresses it, and transmits the decompressed image data to the core unit 117.

The network interface unit 111 is an interface between the information processing apparatus 100 such as a computer or the like connected through an external network and the core unit 117. All of the communication of the job commands, installation information of the add-in, and the like from the information processing apparatus 100 is made through the network interface unit 111. The job commands include a job control command which is transmitted together with PDL data. For example, such a command that after the PDL data was developed and printed as image data, the printed sheet is sorted by using a stapler and delivered is included.

Also in the embodiment, the charge for the add-in function is notified to the printing apparatus 110 by using such a job command. A database called MIB (Management Information Base) has been constructed in the network interface unit 111. The printing apparatus 110 communicates with the information processing apparatus 100 on the network by an SNMP (Simple Network Management Protocol) and can manage the printer unit 119.

The formatting unit 112 is connected to the core unit 117 and develops image forming data such as PDL data or the like included in the job command which was transmitted from the information processing apparatus 100 into image data which can be printed by the printer unit 119.

The image memory unit 113 temporarily stores the information sent from the reader unit 118 or the information sent from the information processing apparatus 100 through the network interface unit 111.

The core unit 117 controls the data or the like flowing among those units, analyzes the job command, collects information such as use situation of the user, the number of copies, the number of print sheets, the number of sheets to be scanned, and the like, and transfers it to the charging apparatus unit 121. The analysis of the job command with respect to use of the add-in functions related to the embodiment and the collection of the information are also executed here.

The charging apparatus unit 121 is connected to the core unit 117, transmits information indicative of the presence or absence of a maintenance contract in accordance with a request from the core unit 117, receives the information such as use situation of the user, the number of copies, the number of print sheets, the number of sheets to be scanned, add-in function, and the like transmitted from the core unit 117, and manages a charging counter.

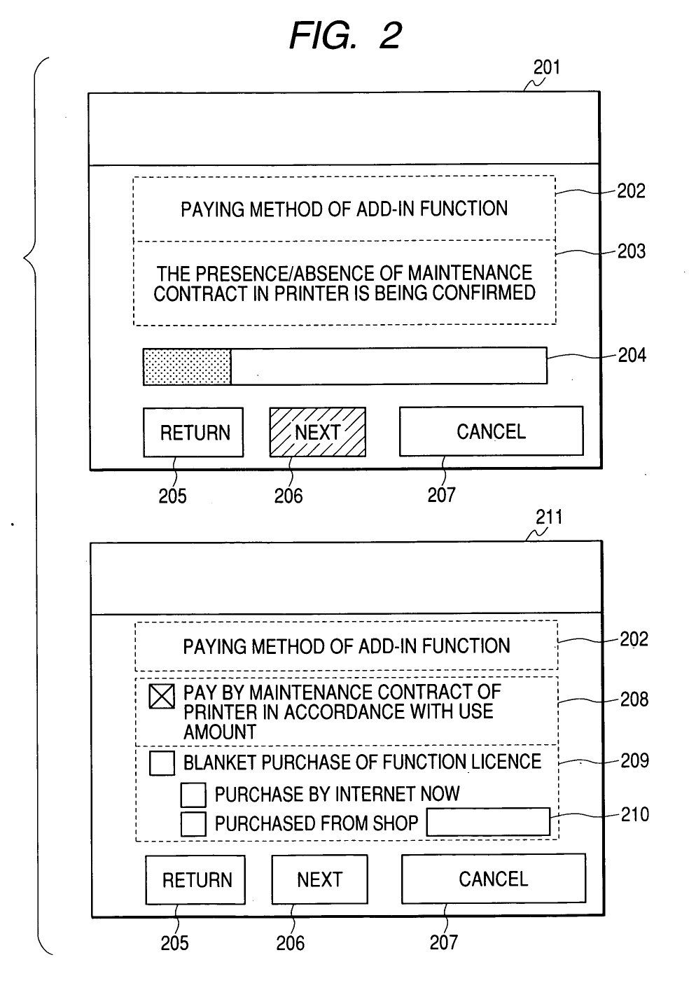

Processes upon installation of the add-in will be described hereinbelow. FIG. 2 shows an example of a user interface display screen of the add-in installer 107 which is displayed when the add-in is installed. In the ordinary installation, when the user activates the add-in installer 107 by means such as a double-click or the like, the add-in installer 107 to install the new additional function to be added is made operative. The add-in installer 107 can be activated by a Web page or can be also automatically activated by a media such as a CD-ROM or the like.

After the activation of the add-in installer 107, a contract written consent is displayed, user consent is confirmed, and thereafter, an installation dialog 201 is displayed. The installation dialog 201 is a dialog regarding a “paying method of the add-in function” 202. As shown in a text box 203, the user is notified that the presence or absence of a maintenance contract in the printing apparatus 110 is being confirmed. A graph showing the elapsed time is shown at 204. This graph informs the user that the process is being executed and also shows a residual examination time. In this case, although a “return” button 205 and a “cancel” button 207 can be selected, a “next” button 206 cannot be selected because the presence or absence of a maintenance contract is being confirmed. After completion of the confirmation of the maintenance contract, if the maintenance contract was made in the printing apparatus 110, a next installation dialog 211 is displayed.

The installation dialog 211 is an installation dialog in the case where the maintenance contract has been made in the printing apparatus 110. The text box 203 and the graph 204 showing the examination time are extinguished and a check box 208 for charging on the basis of the maintenance contract in the printing apparatus 110 in accordance with the use amount of the add-in functions and a check box 209 to purchase the licenses of the add-in functions in a lump are displayed in those extinguished portions. When the check box 208 is selected, the user is charged by the counter on the printing apparatus 110 side in accordance with the use amount of the functions on the basis of the maintenance contract in the printing apparatus 110.

There are two sub check boxes in the check box 209. One of them is the check box for purchasing by the Internet from now. When this sub check box is selected, if the user clicks the “next” button 206, a standard Web browser is activated and homepage to purchase the licenses is displayed. Through this homepage, the user buys the add-in licenses and enters data into an input box 210 of the license key, so that he can make the blanket purchase of the add-in functions. The other is the sub check box for the case where he has already purchased from a shop. By selecting this sub check box and inputting the license key into the input box 210 of the license key, he can make the blanket purchase of the add-in functions.

The information processing apparatus 100 inquires of the printing apparatus 110 about the maintenance contract. If the maintenance contract is not made in the printing apparatus 110, only the user interfaces 209 and 210 for urging the user to enter the charged licenses which the user has already purchased at the shop or through the Internet and which can recognize that the charging contract has already been made are displayed in the dialog 211. When the user enters the charged licenses on the user interface 209, the information processing apparatus 100 transmits the inputted charged license to the printing apparatus 110. The printing apparatus 110 authenticates the validity of the received charged licenses. When the authentication of the validity is confirmed, the charging process is executed.

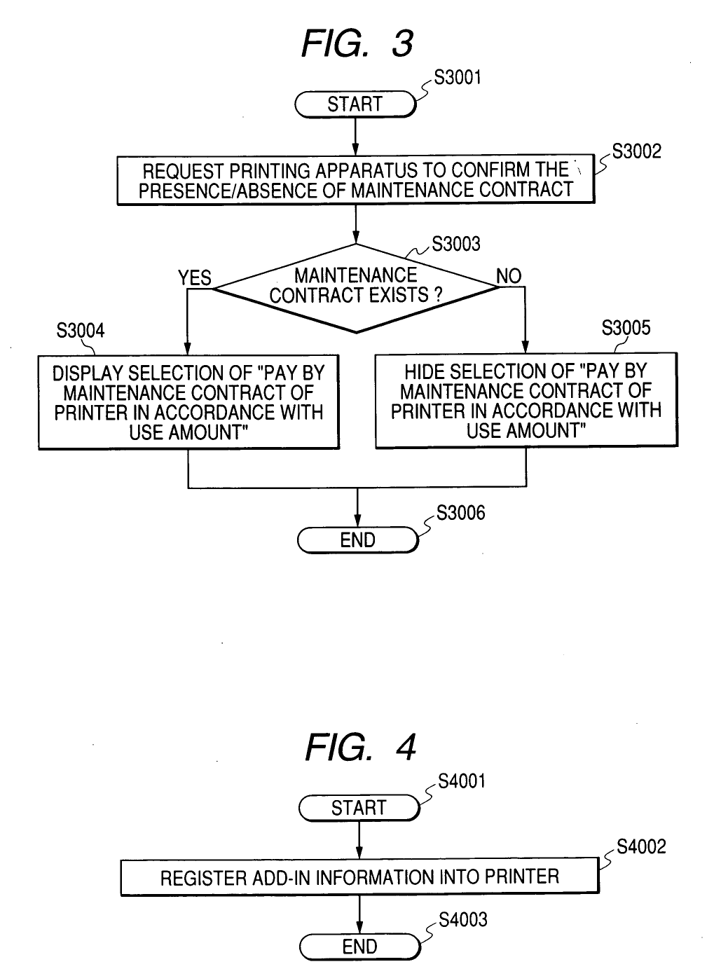

FIG. 3 is a flowchart showing the operation in the add-in installer 107 for displaying the installation dialogs 201 and 211 shown in FIG. 2.

In step S3001, a routine to display the installation dialogs 201 and 211 in the add-in installer 107 is started. Ordinarily, a confirming process of the contract consent necessary at the time of a series of installation such as confirmation of the presence or absence of the software contract consent or the like is executed before this step.

In step S3002, the installation dialog 201 is displayed and the printing apparatus 110 is asked to confirm the presence or absence of the maintenance contract by using a protocol which can be transferred on the network by using communicating means to the LAN extending from the add-in installer 107. The network interface unit 111 in the printing apparatus 110 which received such a confirmation request inquires of the core unit 117 about the presence or absence of the maintenance contract. Thus, the core unit 117 confirms whether or not the maintenance contract has been made at present to the charging apparatus unit 121.

The charging apparatus unit 121 holds information regarding the presence or absence of the present maintenance contract and notifies the core unit 117 of it. The core unit 117 notifies the network interface unit 111 of such information. The network interface unit 111 converts it into information which can be communicated by the network and sends the converted information to the add-in installer 107. At this time, there is a case where it takes a time in dependence on a jam degree of the network or the like. Therefore, the graph 204 showing the time elapse is displayed to show a progressing state to the user. If no response is obtained for a predetermined time due to a defect of the network or the like, it is determined that the maintenance contract is not made, and a necessary procedure is taken.

In step S3003, the presence or absence of the maintenance contract is discriminated. If the maintenance contract has been made in the device, step S3004 is executed. If there is no maintenance contract, step S3005 is executed. Both in steps S3004 and S3005, the check box 209 is displayed to purchase the licenses of the add-in functions in a lump. However, the processes differ with respect to the following points.

In step S3004, the check box 208 showing that the use fee is paid by the maintenance contract of the printing apparatus 110 in accordance with the use amount is displayed. However, in step S3005, such a display is not displayed or is displayed in a semitransparent state, thereby disabling it to be selected. Step S3006 shows a termination of the display routine process of the installation dialogs 201 and 211 in the add-in installer 107 regarding the presence or absence of the maintenance contract. After this process, the installing operation such as file copy for copying the UI add-in 104 and the graphics add-in 106 onto the OS or the like is executed.

FIG. 4 shows a flowchart in the case where the check box 208 for paying in accordance with the use amount on the basis of the maintenance contract of the printing apparatus 110 is selected.

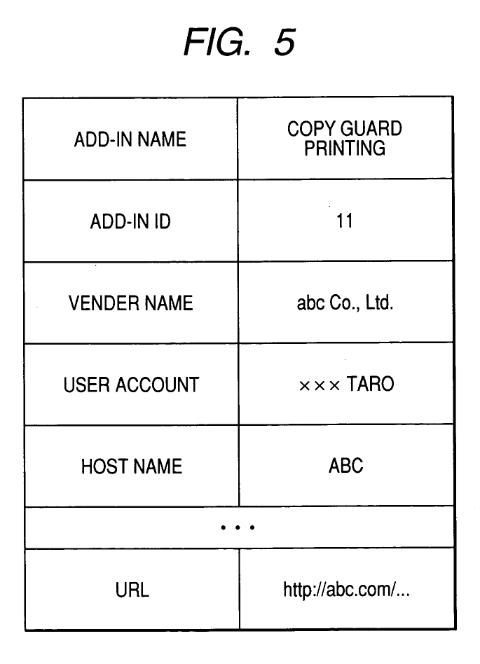

In step S4001, this process is started. This process is executed in the case where after the check box 208 was selected in the installation dialog 211, the “next” button 206 is clicked. In step S4002, the add-in information is registered into the printing apparatus 110 from the add-in installer 107. Information which is sent at the time of this registration is shown in FIG. 5. Step S4003 shows a termination of this process.

FIG. 5 is a diagram showing an example of the information for the add-in registration.

As main information included in this information, an add-in name, an add-in ID, a vender name, a user account, a host name, a URL, and the like can be given. The add-in name is a name of the function to be realized by this add-in. The copy guard printing in which characters are displayed so as to be floating on a background pattern by a difference between reproduction pixels when printed matter is copied is shown here as an example.

The user account designates the name of the user who intends to use this add-in. For example, at the time of the use consent, the user is instructed to enter his name, thereby unconditionally determining the user who can use this license. The host name is a name of the host of the information processing apparatus 100 which intends to install the present add-in. Besides the host name, information that is peculiar to the device such as a Mac address and the like is added to the above information. By sending the user account name and the host name to the printing apparatus 110 and managing them, from which information processing apparatus the add-in function has been used can be specified.

The add-in ID is an ID which is unconditionally added every add-in. To manage the kind of add-in, by combining the ID allocated by the vender of the printing apparatus 110 and the user account name and the host name which are unconditionally determined in the user environment where the add-in is used, the ID which can be certainly and unconditionally determined in the add-in, user, and information processing environment is formed. In this example, “11” is used for simplicity of explanation. By a method whereby a hash value or the like of a key which is used as a license key or the like is added to the information for the add-in registration or the information for the add-in registration is encrypted, forgery of the ID by an illegal user who does not exist or in an information processing environment can be prevented.

The vender name designates a name of a company which has formed the add-in. This information is used when the use fee is paid to the third party. The URL indicates a URL of homepage regarding the add-in of the company which has developed the add-in. By possessing this URL, it is also possible that after the information for the add-in registration is obtained in the printing apparatus 110, the URL is accessed by using a hidden command, the information for the add-in registration is sent, and the validity of the add-in is confirmed.

Although the embodiment has been limited to the case where the add-in has a single function, in the case of the add-in having a plurality of functions, by issuing the information for the add-in registration every function from the add-in installer 107, the addition of the add-in functions can be realized.

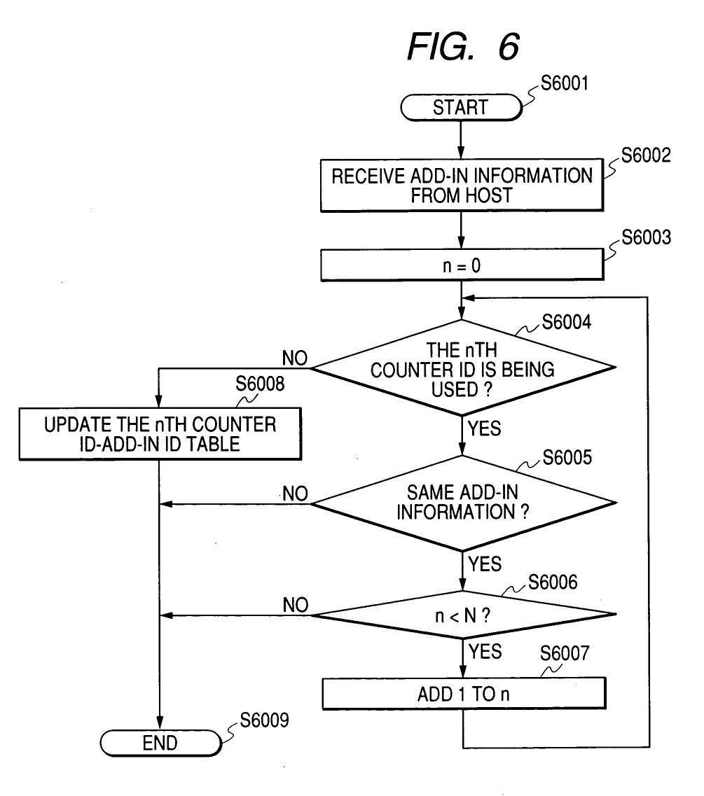

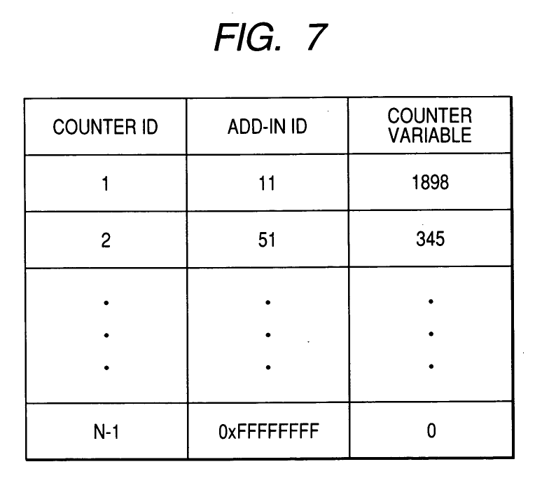

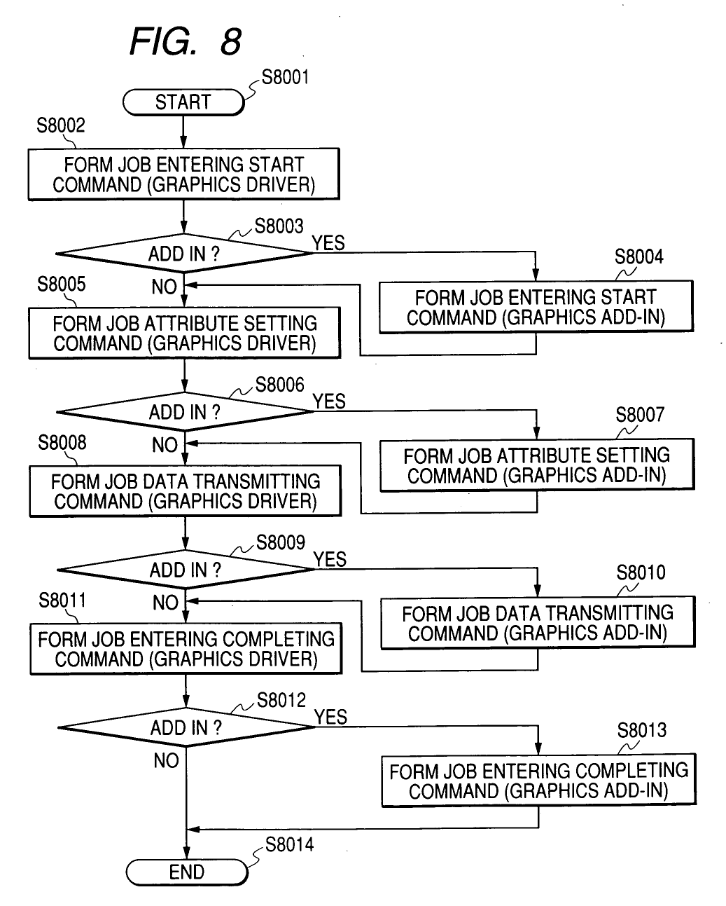

FIG. 6 shows a flowchart for registration into a counter ID—add-in ID management counter in the printing apparatus 110. FIG. 7 shows a data structure of the counter ID—add-in ID management counter. This counter has been stored in the charging apparatus unit 121.

In step S6001, the processing routine is started. To allocate the counter to the add-in which has newly been registered, the network interface unit 111 receives the information for the add-in registration and transmits it to the core unit 117, and thereafter, this process operates in the charging apparatus unit 121 by a request from the core unit 117.

In step S6002, the information for the add-in registration is received from the core unit 117. In next step S6003, a variable (n) is initialized to zero. In step S6004, whether or not the nth counter ID in FIG. 7 has been used is discriminated. If it has been used, step S6005 follows. If it is not used, step S6008 follows. The add-in ID of the counter ID which is not used has been initialized by an ID which is not used at all. In the case of this example, when the add-in ID in FIG. 7 has 0xFFFFFFFF, this means that the counter ID is not used. In the initial state, all IDs are filled with 0xFFFFFFFF.

In step S6005, whether or not the ID of the present add-in has already been registered in the printing apparatus 110 is discriminated with reference to the nth add-in ID. If it is not registered, step S6009 follows. If it has already been registered, step S6006 follows.

In step S6006, if the variable (n) is smaller than the total number-(N) of counters in the counter ID—add-in ID management counter, step S6007 follows. If (n) is equal to or larger than (N), step S6009 follows. In step S6007, “1” is added to the variable (n) and the next counter ID is searched for. In step S6008, the present add-in ID is registered into the add-in ID corresponding to the nth counter ID and the received information for the add-in registration is stored in the charging apparatus unit 121. The counter variable for the nth counter ID to manage the use situation is initialized to “0”. Step S6009 is a termination of this process.

The counter ID—add-in ID management counter in FIG. 7 is a table structure having two elements associated with the counter ID having continuous integer values of 0 to N-1 and has the add-in ID and the counter variable.

The add-in ID is a variable to hold the add-in ID associated with the counter ID. Once the add-in is registered, it is not erased. The counter variable is a variable to hold the use situation of the novel add-in function shown by the add-in ID. When the payment by the maintenance contract is finished, the counter variable is initialized to zero by a maintenance system by a service person or the network.

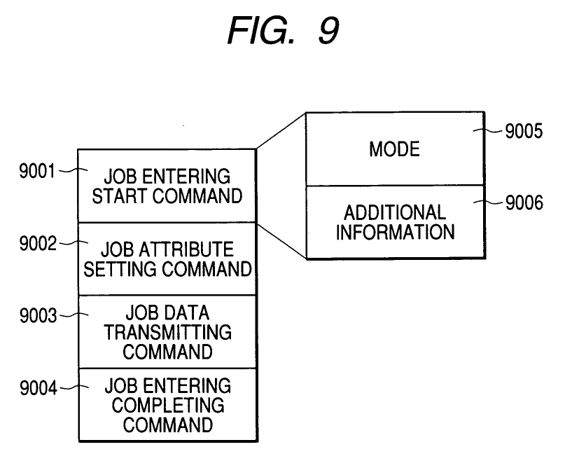

A charging method when each add-in function is used will be described hereinbelow. FIG. 8 shows a flowchart for the operation in the printer driver 106. Job commands which are formed by this process are shown in FIG. 9.

This processing routine is started in Step S8001. If the UI add-in 104 and the graphics add-in 106 have been installed, the add-in functions which the user wants to use have already been selected as print setting information by the UI add-in 104 before this process. Since this operation has already been described in the UI operation using FIG. 1, its explanation is omitted here.

In step S8002, the graphics driver 105 forms a job entering start command on the basis of the print setting information. This process is the creation of a command shown at 9001 in FIG. 9. The job entering start command 9001 is constructed by information called a mode 9005 to specify the processing method in the core unit 117 and additional information 9006 showing details of this mode. In step S8003, whether or not the graphics add-in 106 exists is discriminated. If it exists, step S8004 follows. If it does not exist, step S8005 follows.

In step S8004, the job entering start command formed in step S8002 is received and modified by the graphics add-in 106. At this time, the add-in ID is added to the mode 9005 in accordance with the print setting information in order to show the functions which are realized by the add-in module and are to be charged for. In the case of realizing a plurality of add-in additional functions by this job, a plurality of add-in IDs are added. If their attribute details are necessary, they are described in the additional information 9006.

In step S8005, the graphics driver 105 forms a job attribute setting command on the basis of the print setting information. This process is the creation of a command shown at 9002 in FIG. 9. In next step S8006, whether or not the graphics add-in 106 exists is discriminated. If the graphics add-in 106 exists, step S8007 follows. If it does not exist, step S8008 follows.

In step S8007, the job attribute setting command formed in step S8005 is received and command editing of the novel additional functions in the add-in is performed. The job attribute setting command 9002 includes attributes of modification for the job such as duplex printing, finisher unit 123, and the like. If the third party wants to add a special external apparatus to the printing apparatus 110 and control it by the add-in, the job is modified here on the basis of the print setting information formed by the UI add-in 104.

In step S8008, the graphics driver 105 forms a job data transmitting command. This process is the creation of a command shown at 9003 in FIG. 9. This command is formed on the basis of a DDI constructing the page drawing which is received by the graphics driver 105. In the case of printing a plurality of pages, a command such as a PDL including a plurality of pages constructs this portion.

In step S8009, whether or not the graphics add-in 106 exists is discriminated. If the graphics add-in 106 exists, step S8010 follows. If it does not exist, step S8011 follows. In step S8010, the job data transmitting command formed in step S8008 is received and command editing of the novel additional functions in the graphics add-in 106 is performed. For example, in the case of the copy guard function, in order to draw a special pattern onto a background plane, a PDL command of such a pattern is added before the job data transmitting command formed in step S8008.

In step S8011, the graphics driver 105 forms a job entering completing command on the basis of the print setting information. This process is the creation of a command shown at 9004 in FIG. 9. In response to this command, the printing apparatus 110 recognizes the end of the job command. In step S8012, whether or not the graphics add-in 106 exists is discriminated. If the graphics add-in 106 exists, step S8013 follows. If it does not exist, step S8014 follows. In step S8013, if the modification in the graphics add-in 106 is necessary in the job entering completing command, it is additionally edited. Step S8014 is a termination of this processing routine.

There is a possibility that wrongdoing in which the add-in ID of the mode 9005 among the job commands formed by the above processes is deleted and the charging process is made inoperative in the printing apparatus 110 is executed by a vicious falsifier. As measures against such falsification, it is also possible to use a method whereby all of the job commands are encrypted or a hash value of the job command with a special key is added as a footer of the job command. In one of steps S8004, S8007, S8010, and S8013, a process to stop the printing in the case where the hidden key such as a digital watermark or the like for the add-in ID is added and if the hidden key remains although the add-in ID of the mode 9005 has been erased can be also implemented into the printing apparatus 110.

The job commands formed as mentioned above are transferred from the information processing apparatus 100 to the printing apparatus 110 through the spooler 108. After the job commands are received by the network interface unit 111 of the printing apparatus 110, the job commands are sent to the core unit 117. The core unit 117 finds out the add-in ID in the mode 9005 in the job command and requests the charging apparatus unit 121 to execute the charging process.

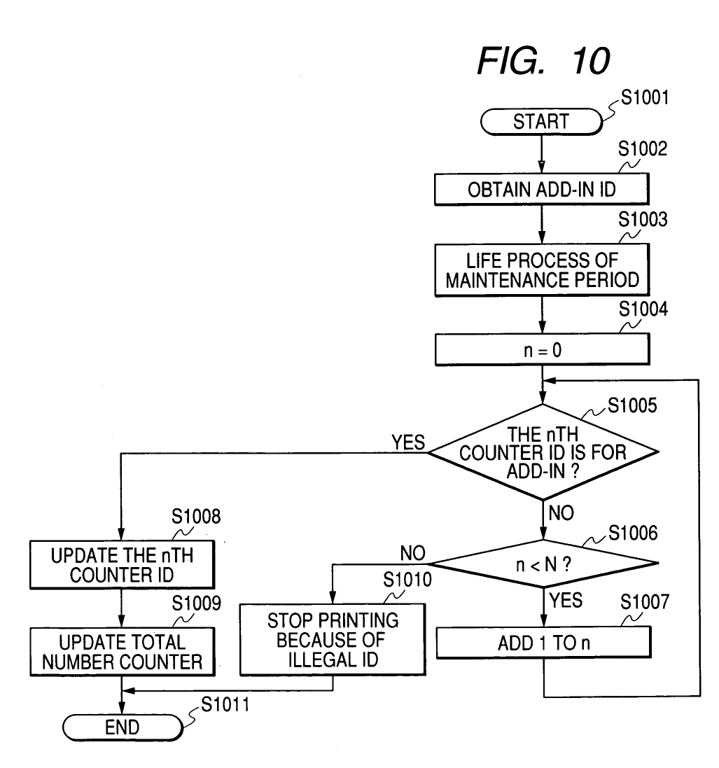

FIG. 10 shows a processing flow for the charging process in the charging apparatus unit 121.

In step S1001, this processing routine is started. If a plurality of add-in IDs are included in the job command, the core unit 117 repeats this process the number of times corresponding to the number of add-in IDs. In step S1002, the add-in IDs are obtained from the core unit 117. The charging apparatus unit 121 has a counter of the time corresponding to the maintenance period. If the maintenance contract has expired and a predetermined period has elapsed, the present add-in ID is replaced by a predetermined illegal value, for example, 0xFFFFFFF0 in step S1003.

In step S1004, the variable (n) is initialized to zero. In step S1005, the add-in ID regarding the nth counter ID of the counter ID—add-in ID management counter shown in FIG. 7 is compared with the present add-in ID. If they are the same add-in ID, step S1008 follows. If they differ, step S1006 follows.

In step S1006, whether or not the variable (n) is smaller than the maximum number (N) of registered counter IDs—add-in IDs is discriminated. If (n) is smaller than (N), step S1010 follows. If (n) is equal to or larger than (N), step S1007 follows. In step S1007, “1” is added to the variable (n) and the next count ID is set to the present ID.

In step S1008, “1” is added to the counter variable for the nth counter ID. In step S1009, the total number counter provided for the charging apparatus unit 121 is updated. This counter shows a total of the use amounts of the individual counters and it is used for verification of the calculation upon charging.

In step S1010, if the present add-in ID cannot be found out in the registered counter, the ID is regarded as an illegal ID and the core unit 117 is notified that the printing of the relevant job command is stopped. Step S1011 is a termination of this processing routine.

It is also possible to construct in such a manner that after the maintenance period has expired, if there is add-in printing, the printing apparatus 110 notifies the UI add-in 104 in each information processing apparatus that the maintenance contract of the add-in has expired by using the add-in information in FIG. 5, thereby allowing the setting items of the relevant function not to be displayed by the add-in UI.

Another embodiment of the invention will now be described.

By implementing the add-in installer 107 into the installer of the UI driver 103 and the graphics driver 105, the UI driver 103, graphics driver 105, UI add-in 104, and graphics add-in 106 can be simultaneously installed.

In the case of installing all driver sets in a lump by using the installer attached to the OS without using the add-in installer 107, by implementing the installing operation of the add-in mentioned above onto a Plug-In function which is specified by the installer attached to the OS, the similar operation can be executed.

Although the related information of the counter IDs and the add-in IDs has been managed by using a fixed table in the embodiment, it can be also managed by using a dynamic link or a hash.

The invention can be applied to a system constructed by a plurality of apparatuses (for example, a host computer, an interface device, a reader, a printer, and the like) or can be also an apparatus (copying apparatus, printer, facsimile apparatus, or the like) comprising one device.

The objects of the invention are also accomplished by a method whereby a storing medium in which program codes for realizing the procedures of the flowcharts shown in the diagrams to realize the functions of the embodiments mentioned above have been stored is supplied to a system or an apparatus and a computer (or a CPU or an MPU) of the system or apparatus reads out the program codes stored in the storing medium and executes them.

In this case, the program codes themselves read out from the storing medium realize the functions of the embodiments mentioned above and the storing medium in which the program codes have been stored constructs the invention.

As a storing medium for supplying the program codes, for example, a flexible disk, a hard disk, an optical disk, a magnetooptic disk, a CD-ROM, a CD-R, a magnetic tape, a non-volatile memory card, a ROM, or the like can be used.

The invention incorporates not only a case where a computer executes the read-out program codes, so that the functions of the embodiments mentioned above are realized but also a case where the OS (Operating System) or the like which operates on the computer executes a part or all of actual processes on the basis of instructions of the program codes and the functions of the embodiments mentioned above are realized by those processes.

Further, the invention incorporates a case where the program codes read out from the storing medium are written into a memory provided for a function expanding board inserted in a computer or a function expanding unit connected to the computer and, thereafter, a CPU or the like provided for the function expanding board or the function expanding unit executes a part or all of actual processes on the basis of instructions of the program codes and the functions of the embodiments mentioned above are realized by those processes.

As mentioned above, according to the embodiments, by confirming the maintenance contract to the printing apparatus, if it is determined that the maintenance contract has been made, for the functions which are realized on the information processing apparatus side by adding the add-in modules to the printer drivers and were not presumed at the beginning of development of the printing apparatus and the printer driver, the means which can charge in accordance with the use amount of the functions by the user instead of the blanket purchase by the ordinary package can be provided.

At this time, the illegal use of the add-in charge can be prevented by encrypting the information for the add-in registration when the add-in is installed or embedding the special key for the purpose of preventing the alteration or illegal use.

By confirming the maintenance contract to the printing apparatus, if it is determined that the maintenance contract is not made or the user wants to make the blanket purchase, by providing a UI for urging the user to enter the license key purchased from the shop or through the Internet, means which does not restrict the use upon blanket purchase can be provided.

As many apparently widely different embodiments of the present invention can be made without departing from the spirit and scope thereof, it is to be understood that the invention is not limited to the specific embodiments thereof except as defined in the claims.

This application claims priority from Japanese Patent Application No. 2003-403555 filed Dec. 2, 2003, which is hereby incorporated by reference herein.

1. An image forming apparatus comprising:
a job command receiving unit for receiving a job command from an external apparatus;
an image forming processing unit for executing an image forming process on the basis of said job command received by said job command receiving unit; and
a charging unit for, if identification information of an additional function is included in said job command, executing a charging process regarding the image forming process by said additional function.

2. An apparatus according to claim 1, further comprising a maintenance contract managing unit for managing whether or not a predetermined maintenance contract has been made to said image forming apparatus, and
wherein said charging unit executes the charging process regarding the image forming process by said additional function with respect to the user which has made said predetermined maintenance contract.

3. An apparatus according to claim 1, further comprising:
a registration information receiving unit for receiving registration information of said additional function including identification information of said external apparatus; and
a registering unit for registering said additional function into said charging unit on the basis of said registration information received by said registration information receiving unit, and
wherein if the identification information of said additional function is included in said job command by registering said additional function by said registering unit, said charging unit executes the charging process regarding the image forming process by said additional function.

4. An apparatus according to claim 1, wherein said job command is an encrypted job command.

5. An apparatus according to claim 1, wherein said job command includes information to prevent alteration of said job command.

6. An image forming system in which an image forming apparatus and an information processing apparatus are connected by a communication line, wherein
said information processing apparatus comprises:
a job command transmitting unit for transmitting a job command to said image forming apparatus, and
said image forming apparatus comprises:
a job command receiving unit for receiving said job command;
an image forming processing unit for executing an image forming process based on said job command received by said job command receiving unit; and
a charging unit for, if identification information of an additional function is included in said job command, executing a charging process regarding the image forming process by said additional function.

7. A system according to claim 6, wherein
said image forming apparatus further comprises:
a maintenance contract managing unit for managing whether or not a predetermined maintenance contract has been made to said image forming apparatus, and
wherein said charging unit executes the charging process regarding the image forming process by said additional function with respect to the user which has made said predetermined maintenance contract.

8. A system according to claim 7, wherein
said information processing apparatus further comprises:
an inquiring unit for inquiring about the presence or absence of said predetermined maintenance contract to said image forming apparatus;
a user interface unit for, if it is determined as a result of the inquiry by said inquiring unit that said predetermined maintenance contract is not made, displaying a user interface for urging the user to enter license information which can recognize that a charging contract has already been made; and
a license information transmitting unit for transmitting the license information entered by the user to said image forming apparatus,
said image forming apparatus further comprises
an authenticating unit for authenticating validity of said license information, and
if the validity of said license information is authenticated by said authenticating unit, said charging unit executes the charging process regarding the image forming process by said additional function.

9. A system according to claim 6, wherein
said image forming apparatus further comprises:
a registration information receiving unit for receiving registration information of said additional function including identification information of said information processing apparatus; and
a registering unit for registering said additional function into said charging unit on the basis of said registration information received by said registration information receiving unit, and
wherein if the identification information of said additional function is included in said job command by registering said additional function by said registering unit, said charging unit executes the charging process regarding the image forming process by said additional function.

10. A system according to claim 6, wherein said job command is an encrypted job command.

11. A system according to claim 6, wherein said job command includes information to prevent alteration of said job command.

12. A charge processing method by an image forming apparatus for executing an image forming process based on a job command from an external apparatus, wherein:
if identification information of an additional function is included in said job command received from said external apparatus, a charging process regarding the image forming process by said additional function is executed.

13. A method according to claim 12, wherein whether or not a predetermined maintenance contract has been made to said image forming apparatus is managed and the charging process regarding the image forming process by said additional function is executed with respect to the user which has made said predetermined maintenance contract.

14. A method according to claim 12, wherein
registration information of said additional function including identification information of said external apparatus is received and if the identification information of said additional function is included in said job command by registering said additional function into a charging unit on the basis of said received registration information, the charging process regarding the image forming process by said additional function is executed.

15. A method according to claim 12, wherein said job command is an encrypted job command.

16. A method according to claim 12, wherein said job command includes information to prevent alteration of said job command.

17. An information processing apparatus which can install a plug-in driver for forming output data which is transferred to an image forming apparatus and allowed to be output-processed, comprising:
an instructing unit for instructing whether or not a use situation of said plug-in driver is charged for by a measured rate before said plug-in driver is installed; and
a setting unit for activating a mechanism which is a function for managing the use situation of said plug-in driver and is possessed by said image forming apparatus side in the case where said instructing unit instructs to charge for by the measured rate.

18. A method of controlling an information processing apparatus which can install a plug-in driver for forming output data which is transferred to an image forming apparatus and allowed to be output-processed, comprising:
an instructing step of instructing whether or not a use situation of said plug-in driver is charged for by a measured rate before said plug-in driver is installed; and
a setting step of activating a mechanism which is a function for managing the use situation of said plug-in driver and is possessed by said image forming apparatus side in the case where it is instructed in said instructing step that the use situation is charged for by the measured rate.

19. A program for allowing a computer to execute a charge processing method according to claim 12.

20. A program for allowing a computer to execute a charge processing method according to claim 18.
